(19) United States
(12) Patent Application Publication
(10) Pub. No.: US 2014/0042738 A1
(43) Pub. Date: Feb. 13, 2014

(54) SECURITY ELEMENT

(71) Applicants: Gary Fairless Power, Craigieburn (AU); Phei Lok, Craigieburn (AU); Robert Arthur Lee, East Burwood (AU)

(72) Inventors: Gary Fairless Power, Craigieburn (AU); Phei Lok, Craigieburn (AU); Robert Arthur Lee, East Burwood (AU)

(73) Assignee: INNOVIA SECURITY PTY LTD, Craigieburn (AU)

(21) Appl. No.: 14/006,231

(22) PCT Filed: Mar. 20, 2012
(86) PCT No.: PCT/AU12/00282

§ 371 Date: Oct. 30, 2013

(30) Foreign Application Priority Data
Mar. 22, 2011 (AU) 20111000315

(51) Int. Cl. B42D 15/00

(52) U.S. Cl. CPC B42D 15/00
USPC 283/85; 427/163.1; 427/58

(57) ABSTRACT

A polarising security element for polarising light of a predetermined wavelength including a first dielectric material having a refractive index nb and at least one polarising region of mutually parallel segments of a second material having a refractive index np which is different from nb, the second material being a dielectric or conducting material. The segments of the second material are in contact with the first material and the segments have a width and/or an average spacing which is less than a predetermined range of wavelengths. A method of manufacturing such a security element in which a relief structure is embossed in the layer of the first dielectric material, the relief structure includes mutually parallel peaks and troughs, and the second layer of dielectric or conducting material is applied on the relief structure to form the at least one polarising region of mutually parallel segments.

### PRIORITY CLAIM

This patent application is a U.S. National Phase of International Patent Application No. PCT/AU2012/000282, filed 20 Mar. 2012, which claims priority to Australian Patent Application No. 2011100315, filed 22 Mar. 2011, the disclosures of which are incorporated herein by reference in their entirety.

### FIELD

Disclosed embodiments relate to security elements having an at least partially polarising effect, and to methods of their manufacture.

### BACKGROUND

Security printers face a constant challenge in staying ahead of counterfeiters, who have increasing access to advanced replication technology. For example, printed elements and diffractive relief structures, which are commonly used as security features in banknotes, can be susceptible to reproduction by optical scanning and contact copying, respectively.

The security document designer must therefore employ increasingly technically advanced features for securing documents against forgery. One approach is to employ a combination of overt and covert security features in the same area of the security document. The overt feature, as its name suggests, is readily apparent to a person viewing the security document with the naked eye, whilst the covert feature becomes apparent under special lighting conditions, for example under UV light or when viewed through a polariser.

One known form of polarising element is described in U.S. Pat. No. 4,484,797. A substractive colour filter is manufactured by embossing a surface relief, such as a square diffraction grating, into a thermoplastic material of an index of refraction n3, and then coating the crests and troughs of the relief structure by evaporation or sputtering of a high refractive index (HRI) material having a substantially greater refractive index n1. The surface is then overcoated with a material having index of refraction n2 which is substantially lower than n1. The resultant “buried grating” device may be designed to produce a change in colour on tilting of the device, together with pronounced polarisation of the transmitted or reflected light. It is also difficult to counterfeit, because the embedding of the material of refractive index n1 makes it impossible for a counterfeiter to reproduce the required physical structure by contact copying. For strong polarisation effects to be observed with such devices, it is generally necessary that the spacings between the grooves of the buried grating be much less than the wavelength of the light beam illuminating the device. This is so that there are no propagating diffraction orders at normal incidence of the illuminating light beam, and the colour change is observed only in the zero order of the device, i.e. direct reflection of the illuminating source.

A problem with known buried grating or zero order diffraction (ZOD) devices is that it is difficult to manufacture them efficiently. The process described in U.S. Pat. No. 4,484,797 requires sputtering or evaporation of the HRI material onto the grating structure. In order to achieve an even coating of HRI material on the relief structure, the coating procedure must be carried out at normal incidence. If the coating is carried out at oblique incidence, special grating geometries must be used. Such processes are not suitable in situations where high throughput is required, for example in the manufacture of banknotes and other high-volume security documents.

A further disadvantage of ZOD devices manufactured by known techniques is that they are limited to being zero-order gratings comprising straight line grooves of equal spacing.

### DEFINITIONS

Security Document

As used herein, the term security document includes all types of documents and tokens of value and identification documents including, but not limited to the following: items of currency such as banknotes and coins, credit cards, cheques, passports, identity cards, securities and share certificates, driver's licences, deeds of title, travel documents such as airline and train tickets, entrance cards and tickets, birth, death and marriage certificates, and academic transcripts.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that

L_{T}<L_{O}, where L_{O} is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink may be curable by ultraviolet (UV) radiation. Alternatively, the radiation curable ink may be cured by other forms of radiation, such as electron beams or X-rays.

The radiation curable ink may be a transparent or translucent ink formed from a clear resin material. Such a transparent or translucent ink is particularly suitable for printing light-transmissive security elements such as sub-wavelength gratings, transmissive diffractive gratings and lens structures.

In at least one disclosed embodiment, the transparent or translucent ink may comprise an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink may be embossed and cured by ultraviolet (UV) radiation at substantially the same time. In another disclosed embodiment, the radiation curable ink is applied and embossed at substantially the same time in a Gravure printing process.

Optionally, in order to be suitable for Gravure printing, the radiation curable ink has a viscosity falling substantially in the range from about 20 to about 175 centipoise, and may be from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer may comprise a primer layer, and the primer layer may include a polyethylene imine. The primer layer may also include a cross-linker, for example a multi-functional isocyanate. Examples of other primers suitable for use in the disclosed embodiments include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

The type of primer may vary for different substrates and embossed ink structures. Optionally, a primer is selected which does not substantially affect the optical properties of the embossed ink structure.

### SUMMARY

In view of the deficiencies of known methods of manufacturing polarising security elements as described above, it is desirable to provide a more efficient method of making such devices.

### BRIEF DESCRIPTION OF THE DRAWINGS

Disclosed embodiments are now described, by way of non-limiting example only, by reference to the accompanying drawings in which:

FIG. 1 shows a perspective view of a polarising security element according to at least one disclosed embodiment;

FIG. 2(A) shows a cross-section through the security element of FIG. 1, part way through its manufacture;

FIG. 2(B) is a cross-sectional view of the completed security element of FIG. 1;

FIG. 3 is a cross-section through an alternative security element;

FIG. 4 shows a cross-section of yet another alternative security element;

FIGS. 5(a) to 5(d) show a plan view of an optical security device having an overt and a covert security feature; and

FIG. 6 shows a plan view of another security element according to at least one disclosed embodiment.

### DETAILED DESCRIPTION OF THE DISCLOSED EMBODIMENTS

Disclosed embodiments provide a method of manufacturing a polarising security element for polarising light of a predetermined range of wavelengths, including:

embossing a relief structure in a first layer of a dielectric material having a refractive index nb, the relief structure including a plurality of mutually parallel peaks and/or troughs, and

applying a second layer of dielectric or conducting material on the relief structure to form at least one polarising region of mutually parallel segments of the dielectric or conducting material along the peaks and/or troughs, the dielectric or conducting material having a refractive index np which is different to nb,

wherein the segments have a width and/or an average spacing which is less than the predetermined wavelength range.

Optionally, the second layer of dielectric or conducting material is applied on the relief structure by printing.

Printing techniques are more efficient than evaporation or sputtering for high-throughput applications such as banknote production. This allows the polarising security element to be manufactured in an entirely in-line process, either on its own or as part of a printing process for a security document such as a banknote.

Another disclosed embodiment provides a polarising security element for polarising light of a predetermined range of wavelengths, including:

a layer of a first dielectric material having a refractive index nb; and

at least one polarising region of mutually parallel segments of a second material having a refractive index np which is different to nb, the second material being a dielectric or conducting material;

wherein the segments are in contact with the first material; and

wherein the segments have a width and/or an average spacing which is less than the predetermined wavelength range.

The polarisation effect may be optimal at a particular wavelength within the predetermined range the “optimal wavelength”. However, it may still be effective for other wavelengths within the predetermined range of wavelengths.

In at least one disclosed embodiment, the width and/or average spacing is not greater than half the optimal wavelength. The polarisation efficiency of the device is optimised when the spacing between elongate segments or the width of the elongate segments is about half the optimal wavelength or less.

Optionally, the segments are embedded between the first layer and a third layer of dielectric material. The dielectric material of the third layer may have a refractive index nt which is different to np. In an alternative, the dielectric material of the third layer may be the same as the dielectric material of the first layer. An embedded structure is not possible to reproduce by contact copying, thus improving the security of the polarising security element.

In another disclosed embodiment, the segments are elongate segments. The elongate segments may have a length which is at least five times greater than their width.

The security element may include a plurality of polarising regions which vary in colour and/or polarisation. The width and/or average spacing of the segments may be different in the different polarising regions of the security element to produce the variations in colour and/or polarisation. Secondly, the curvature of the segments in the plane of the security element may be made different in the different polarising regions to produce the variations in colour and/or polarisation.

In yet another disclosed embodiment, the at least one polarising region exhibits a change of colour on tilting or rotation of the security element, for example when the security element is rotated about an axis which is perpendicular to a plane defined by the segments of the polarising region or regions.

The polarising regions may form a tonal monochromatic or polychromatic image which changes appearance on tilting or rotation of the device, and which also changes appearance when viewed under a polariser. For example, each polarising region could be a zero order diffraction grating of a particular colour and brightness. The security element could comprise a large number of such polarising regions, for example in the form of strips or pixels, each of which has at least one dimension which is smaller than the resolution of an unassisted human eye. The strips or pixels would thus be imperceptible as individual elements but would, in combination, produce a tonal image such as a portrait which changes colour on tilting or rotation to provide a first, overt, optical effect. When viewed under a polariser, a second optical effect would become apparent due to the variation in polarisation across the security element.

In some disclosed embodiments the security element may include at least one non-polarising region which may exhibit a diffractive (i.e., non-zero order), reflective or refractive optically variable effect. The relief structure may include multiple polarising regions interlaced or interspersed with multiple non-polarising regions, each polarising or non-polarising region may have at least one dimension which is smaller than the resolution of an unassisted human eye.

The polarising regions in such embodiments may produce an overt optical effect under illumination by visible light, in addition to an overt optical effect produced by the non-polarising regions, so that when viewed without the assistance of a polariser, the interlaced or interspersed polarising and non-polarising regions produce a composite image. When viewed under an appropriate polarising filter, the polarising regions may be made to disappear or change colour so that a different image consisting only of non-polarising regions becomes visible.

In still another disclosed embodiment, the security element may include first polarising regions of a first polarisation, interlaced with second polarising regions of a second polarisation which is different (optionally orthogonal) to the first polarisation. The first and second polarising regions may together produce a first composite image under illumination by unpolarised light, and a second, different image when the security element is viewed under polarised light.

Optionally, each polarising region (and each non-polarising region, if present) has at least one dimension smaller than 100 microns. For example, the polarising or non-polarising regions may be strips having a width less than 100 microns, or square or approximately square pixels having side lengths less than 100 microns. If the regions are strips, they may have a length greater than 500 microns.

The second layer may comprise conducting, optionally metallic, nanoparticles, and in at least one disclosed method, these may be applied (for example, by a printing process such as rotogravure printing) as a layer of high viscosity ink such that the elongate segments lie along the peaks of the relief structure. Optionally, the thickness of the ink is substantially less than the height (i.e., the vertical distance between the peaks and the troughs) of the peaks of the relief structure, to ensure that the material of the second layer is applied only to the peaks, and not the troughs, of the relief structure.

Alternatively, the second layer may be applied as a layer of low viscosity ink so that the segments lie along the troughs of the relief structure. The low viscosity ink may contain conducting nanoparticles in a liquid or resin vehicle at a concentration which is proportional to the width of the segments. Alternatively, at least one dimension of the nanoparticles may be proportional to the width of the segments.

It is also possible that a layer of ink may be applied over both the peaks and troughs, e.g. in a uniformly metallised relief structure which can generate polarisation effects.

Optionally, the conducting nanoparticles are surface-treated to assist their dispersion in the liquid or resin vehicle.

The method may further include the step of removing the vehicle to form the segments.

In disclosed embodiments where the segments include metallic nanoparticles, the method may further include the step of annealing the nanoparticles to form a bulk material. This may provide an additional irreversible security feature in some applications.

In at least one disclosed process, the first dielectric material is an embossable radiation curable ink. The embossable radiation curable ink may be applied to a substrate by a printing process, embossed, and cured to form the relief structure. The curing step may occur substantially simultaneously with the embossing step, or may be performed at a separate curing station.

In disclosed embodiments where a third layer of material is applied, the third layer may be applied by a printing process.

The relief structure may be applied by an embossing cylinder having an axis of rotation which is aligned substantially perpendicular to the peaks and troughs of the relief structure. Having a relief structure with this relative alignment helps to ensure that the structure is not damaged due to torsional forces as the cylinder separates from the embossed structure, particularly when the depth of the relief structure is significantly greater than the separation between neighbouring peaks or troughs. This also assists in overcoming processing difficulties such as clogging of inks within the grooves of the relief structure between the steps of inking the cylinder and transfer of ink onto the substrate.

The predetermined wavelength may be less than 1 μm, and may be in the range 400 nm to 700 nm.

In at least one disclosed embodiment, the security element includes a layer of light-absorbing material applied to either the first layer or, if applicable, the third layer of the device.

In a further disclosed embodiment, there is provided an optical security device including a polarising security element according to any of the above embodiments, or a polarising security element manufactured according to any of the methods described above.

Optionally, the polarising security element is applied to a substrate.

Another disclosed embodiment provides a security document including an optical security device as described above.

Optionally, the optical security device is formed in or on a window or half-window region of the security document.

Another disclosed embodiment provides an authenticating arrangement, including a security document according to the fourth aspect of the invention or an optical security device according to the third aspect of the invention, the authenticating arrangement further including at least one polariser for viewing the optical security device. If the authenticating arrangement includes a security document, it may be a foldable security document such as a banknote. The optically variable device and polariser may be spatially separated on the security document, such that the polariser and optically variable device can be brought into overlapping arrangement in order to view the optical security device.

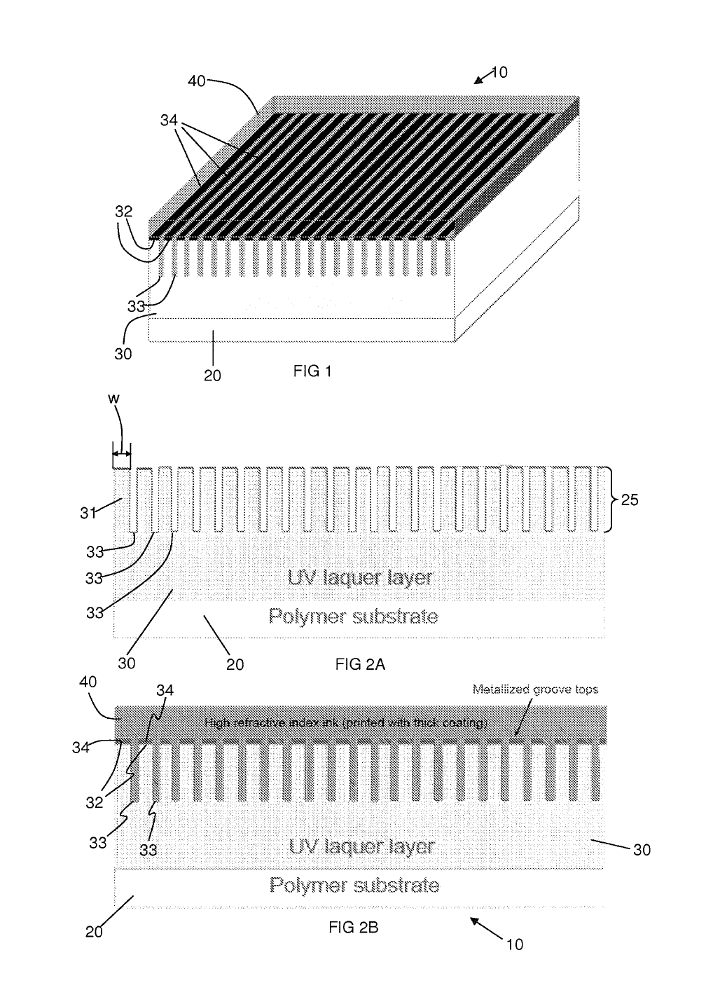

Referring to FIGS. 1, 2(A) and 2(B), there is shown a polarising security element 10. The security element 10 includes a transparent or translucent substrate 20 to which a first layer 30 of a dielectric material having a refractive index nb is applied. Embossed into the first layer 30 is a relief structure having a plurality of grooves forming mutually parallel peaks 32 and troughs 33. The peaks 32 have a width w which is less than a predetermined range of wavelengths. For operation of the security element in the visible region, the predetermined wavelength range would lie in the approximate range 0.4 to 0.7 microns.

In FIG. 2(A), a series of grooves 31 of width w has been embossed into a suitable dielectric material 30, for example a radiation curable ink which is applied to the substrate 20, to form a relief structure 25. The grooves 31 may be embossed and cured substantially simultaneously. The high aspect ratio relief structure 25 of FIG. 2(A) has a groove depth of the order of 5 to 10 microns and a substantially constant groove spacing (distance between neighbouring peaks 32 or troughs 33) which lies in the range 0.25 to 0.5 microns.

Following embossment of the grooves 31, a printing apparatus (for example, a rotogravure printing plate) carrying a metallic ink of thickness of the order of 1 to 2 microns, i.e. substantially less than the depth of grooves 31, is used to apply the metallic ink to the peaks 32 of the grooves 31. Because the ink thickness is less than the groove depth, only the peaks 32 will be covered with metallic ink and therefore become electrically conducting, as shown in FIGS. 1 and 2(B). The metallic ink forms elongate segments 34 of conducting material along the peaks 32 of the grooves 31 of relief structure 25. The refractive index np of the conducting material forming the elongate segments 34 is different to the refractive index nb of the dielectric material 30 into which the relief structure 25 is embossed.

The metallic ink applied to the peaks 32 may comprise metallic nanoparticles, for example gold or silver nanoparticles. Silver nanoparticle inks suitable for use with at least one disclosed embodiment include nanosilver inks manufactured by Advanced Nano Products, Cima NanoTech or NPK Co., Ltd, and having a viscosity of 5 Centipoise or greater.

The width w of the elongate segments may be half an optimal wavelength in the predetermined wavelength range in order to maximise the polarisation efficiency of the security element 10. For example, for an optimal wavelength of 550 nm, the width w may be 0.275 microns (275 nm). The groove spacing may be the same as the width w of the elongate segments, but is not necessarily so. The groove spacing may be varied as desired to achieve various optical effects. For example, the groove spacing can be chosen so that the relief structure 25 produces a first-order diffractive optically variable effect in the visible region, whilst also producing a polarising effect due to the mutually parallel conducting elongate segments 34.

After the metallic ink has been applied to relief structure 25 to form the elongate segments 34, a layer 40 of a further dielectric material having refractive index nt may be overcoated on the relief structure 25. Layer 40 may comprise a high refractive index ink having refractive index nt. If nt is greater than nb (optionally having real part Re(nt) which is greater than Re(nb) by 0.2 units or more) then the diffractive effect from the relief structure 25 will be a combination of both phase and amplitude contributions; the phase contributions coming from the high aspect ratio microstructure 25 and the amplitude effect coming from the metallized groove tops 34.

If the coating 40 has a similar refractive index to the UV lacquer layer 30, nt nb, then the diffraction effect will have only an amplitude component from the metallized groove tops 34. However in both cases a polarization effect will be created with light waves with their electric vectors aligned parallel to the conducting groove tops 34 being absorbed in the generation of electric currents in the groove tops 34, the security element therefore acting as a wire grid polariser.

Turning now to FIG. 3, there is shown an alternative polarising security element 100 in which a layer of a first dielectric material 130 of refractive index nb is applied to a substrate 120 and then embossed to form relief structure 125. The relief structure 125 includes a series of grooves 131 of alternating peaks 132 and troughs 133, the groove spacing W of the relief structure being less than a predetermined range of wavelengths and may be around half an optimal wavelength in the predetermined wavelength range (for example, about 325 nm if the device is to polarise incident red light).

After embossment, a layer of a second dielectric material 134 having refractive index np is applied to the peaks 132 of the relief structure 125 by a printing process as described above. The refractive index np of the second dielectric material is different to the refractive index nb of the first dielectric material.

The second dielectric material applied to peaks 132 forms elongate segments 134. Each segment 134 is separated from its nearest neighbour by a distance W, i.e. the groove spacing of relief structure 125.

The two dielectric layers 130, 134 may then be overcoated with a further dielectric layer 140, the material of the dielectric layer 140 having a refractive index nt which may be approximately equal to the refractive index nb of the first dielectric layer 130. The elongate segments 134 in this embodiment are thus embedded between two dielectric materials of similar refractive index and form a buried zero order grating structure. The buried grating produces a colour change on rotation of the device, and light reflected or transmitted from the buried grating is also strongly polarised.

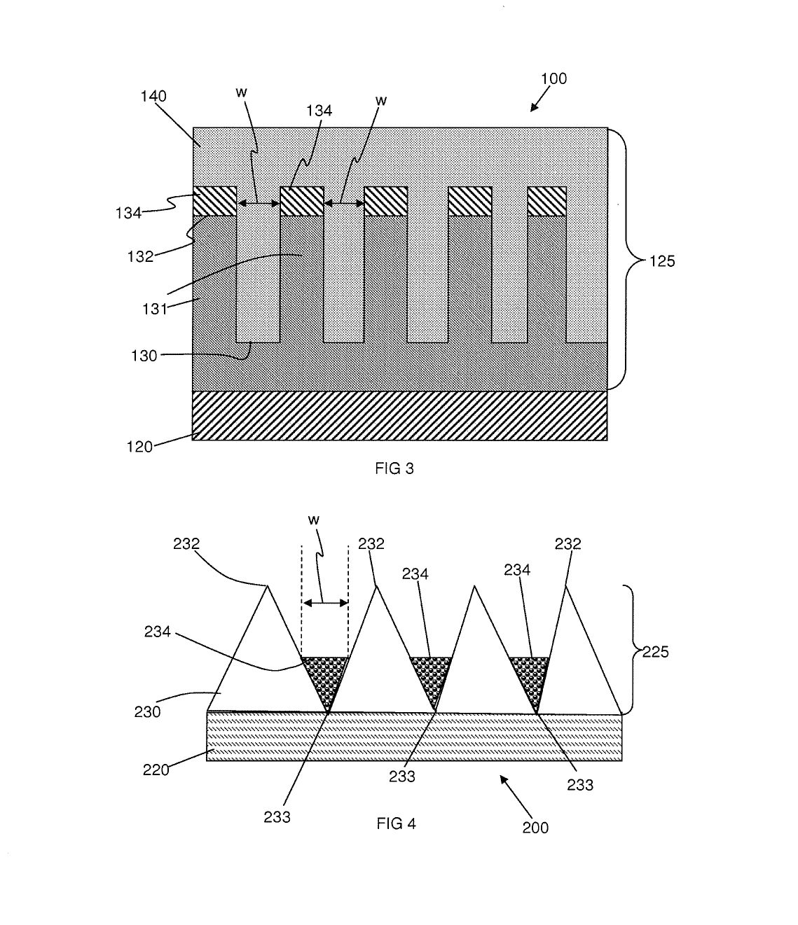

In FIG. 4 there is shown yet another disclosed embodiment, in which a polarising security element 200 comprises a substrate 220 on which are disposed a series of triangular grooves embossed into a layer 230 of a dielectric material to form a relief structure 225, and including alternating peaks 232 and troughs 233. The peaks 232 of relief structure 225 are shown in FIG. 4 as sharp points, though it will be appreciated that they may also be flattened so that the profile of each groove is quadrilateral rather than triangular.

After the relief structure 225 is formed, a low viscosity nanoparticle-containing ink solution is applied to the relief structure 225, so that the nanoparticle ink flows into troughs 233. The solvent of the ink is then allowed to evaporate so that elongate segments of nanoparticles, having refractive index np which is different to the refractive index nb of the dielectric layer 230, are left in troughs 233. The width W of each elongate segment is less than a predetermined wavelength range, and can be controlled by varying the concentration of nanoparticles in the ink solution which is applied to the relief structure 225. The relief structure 225 may then optionally be overcoated with a layer of a further dielectric material, the further dielectric material having a refractive index nt which may be substantially the same as nb.

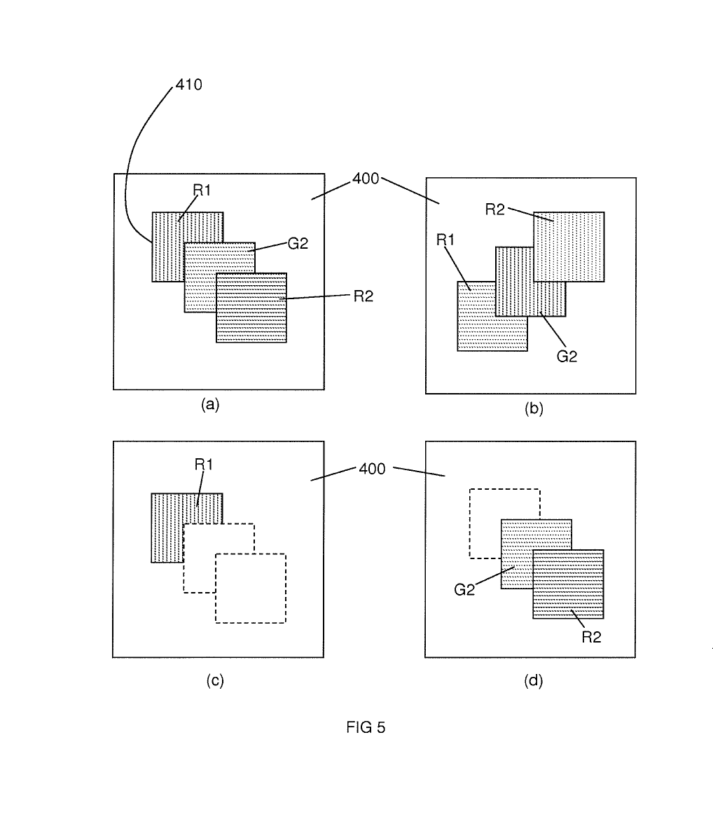

Turning now to FIG. 5(a), there is shown a plan view of an optically variable device 400 including a security element 410 comprising three polarising regions R1, R2, G2. Each of the three regions may take a form similar to one of the polarising elements shown in FIGS. 1 to 4. For example, regions R1 and R2 could be zero-order diffraction gratings 100 with an average groove spacing of around 325 nm, so that R1 and R2 both appear red at normal incidence. Region G2 could be a zero-order diffraction grating 100 with an average groove spacing of around 255 nm, so that G2 appears green at normal incidence. Region R1 produces light having a first polarisation, and region R2 is similar, except that the grooves of region R1 are aligned orthogonally to those of region R2, i.e. region R2 produces light having a second polarisation which is orthogonal to the first polarisation. Region G2 has grooves aligned in the same direction as R2, and as such, polarises incident light in the same direction as R2.

When the optically variable device 400 is rotated 90 degrees in its own plane, as shown in FIG. 5(b), each of the zero-order diffraction gratings R1, R2, G2 undergoes a colour change. Regions R1 and R2 now appear green, whilst region G2 appears red.

In addition to the overt security feature depicted in FIG. 5(b), the optically variable device 400 also embodies a covert security feature. If the device 400 is viewed through a polarising filter (not shown) which allows only the first polarisation to pass, then only region R1 will be visible, as shown in FIG. 5(c) (in which dotted outlines depict the areas occupied by regions R2 and G2). On the other hand, if viewed through a polarising filter which allows only the second polarisation to pass, then only regions R2 and G2 will be visible (FIG. 5(d)).

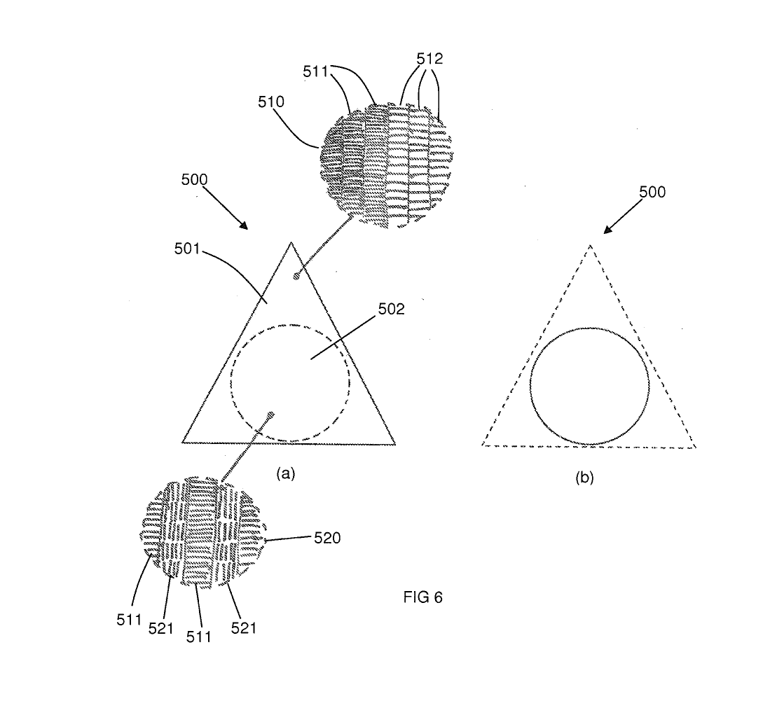

Referring to FIG. 6(a), there is shown an alternative security element 500 which comprises a relief structure having a plurality of first polarising regions 511, 512 and a plurality of second polarising regions 521.

The security element 500 has a first area 501, part of which is shown magnified at 510, which contains only polarising regions 511, 512 having a first direction of polarisation. The polarising regions 511, 512 may be wire grid polarisers 10 or may instead be zero-order diffraction gratings 100. The colour of the polarising regions may be modulated by varying the average groove spacing, so that, for example, polarising regions 511 have an average groove spacing of about 255 nm (green) and polarising regions 512 have an average groove spacing of about 325 nm (red).

In a second area 502 of the security element 500, shown as a dotted-outline circle, the relief structure comprises interlaced strips of polarising regions 511 and 521. Regions 521 have the same groove spacing as regions 511 but have grooves which are oriented perpendicularly to those of regions 511, i.e. they appear to have the same colour, but regions 521 polarise incident light with a first polarisation which is orthogonal to a second polarisation produced by regions 511. Each strip 511, 521 has a width which is less than the resolution of the human eye, and so individual strips cannot be perceived by a viewer, who merely sees a coloured triangle—the second area 502 is not separately discernible. However, if the security element 500 is viewed through a polariser which filters light of the first polarisation, only the polarising regions 521 are visible, so that the viewer sees a coloured circle 502 (FIG. 6(b)).

A number of variations of the embodiment shown in FIGS. 6(a) and 6(b) are possible. For example, polarising regions 521 could be replaced by diffractive (non-polarising) regions, so that when the security element 500 is viewed through a polarising filter which does not allow light of the first polarisation to pass, polarising regions 511, 512 are no longer visible and the viewer sees a circle 502 which displays a diffractive optically variable effect.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A polarising security element for polarising light of a predetermined range of wavelengths, comprising:
a layer of a first dielectric material having a refractive index nb; and
at least one polarising region of mutually parallel segments of a second material having a refractive index np which is different to nb, the second material being a dielectric or conducting material,
wherein the segments are in contact with the first material; and
wherein the segments have a width and/or an average spacing which is less than the predetermined wavelength range.

37. The security element of claim 36, further comprising a third layer of a dielectric material, wherein the segments are embedded between the first layer and the third layer.

38. The security element of claim 36, wherein the segments are elongate segments having a length which is at least five times greater than their width.

39. The security element of claim 36, wherein the dielectric material of the third layer is the same as the dielectric material of the first layer.

40. The security element of claim 36, wherein the material of the second layer includes conducting nanoparticles.

41. The security element of claim 36, wherein the security element includes a plurality of polarising regions which vary in colour and/or polarisation.

42. The security element of claim 41, wherein the width and/or average spacing of the segments is different in different polarising regions to produce the variations in colour and/or polarisation.

43. The security element of claim 41, wherein the curvature of the segments is different in different polarising regions to produce the variations in colour and/or polarisation.

44. The security element of claim 36, wherein the at least one polarising region exhibits a change of colour on tilting or rotation of the security element.

45. The security element of claim 44, wherein the change or colour occurs upon rotation about an axis which is perpendicular to a plane defined by the segments of the at least one polarising region.

46. The security element of claim 41, wherein the polarising regions form a tonal monochromatic or multicoloured image which changes appearance on tilting or rotation of the device, and which also changes appearance when viewed under a polariser.

47. The security element of claim 36, wherein the relief structure includes at least one non-polarising region.

48. The security element of claim 47, wherein the at least one non-polarising region exhibits a diffractive, reflective or refractive optically variable effect.

49. The security element of claim 47, wherein the relief structure includes multiple polarising regions interlaced or interspersed with multiple non-polarising regions.

50. The security element of claim 47, wherein each polarising region or non-polarising region has at least one dimension which is smaller than the resolution of an unassisted human eye.

51. The security element of claim 50, wherein each polarising region or non-polarising region has at least one dimension smaller than 100 microns, and preferably each polarising region or non-polarising region has a width smaller than 100 microns and a length greater than 500 microns.

52. The security element of claim 36, wherein the predetermined wavelength is less than 1 μm.

53. An optical security device comprising a polarising security element of claim 36.

54. A security document comprising an optical security device of claim 53.

55. The security document of claim 54, wherein the optical security device is formed in or on a window or half-window region of the security document.

56. An authenticating arrangement, comprising a security document of claim 54, the authenticating arrangement further including at least one polariser for viewing the optical security device.

57. The authenticating arrangement of claim 56, wherein the polariser forms part of the optical security device or security document.

58. The authenticating arrangement of claim 57, wherein the security document is foldable to bring the polariser into register with the optical security device.

59. A method of manufacturing a polarising security element for polarising light of a predetermined range of wavelengths, comprising:
embossing a relief structure in a first layer of a dielectric material having a refractive index nb, the relief structure including a plurality of mutually parallel peaks and/or troughs; and
applying a second layer of dielectric or conducting material on the relief structure, preferably by printing, to form at least one polarising region of mutually parallel segments of the dielectric or conducting material along the peaks and/or troughs, the dielectric or conducting material having a refractive index np which is different to nb,
wherein the segments have a width and/or an average spacing which is less than the predetermined wavelength range.

60. The method of claim 59, wherein the relief structure is applied by an embossing cylinder having an axis of rotation which is aligned substantially perpendicular to the peaks and troughs of the relief structure.

61. The method of claim 59, wherein the second layer has a thickness which is substantially less than the height of the peaks of the relief structure, whereby the material of the second layer is applied only to the peaks and not to the troughs of the relief structure.

62. The method of claim 60, wherein the second layer is applied as a layer of high viscosity ink, whereby the segments lie along the peaks of the relief structure.

63. The method of claim 59, wherein the second layer is applied as a layer of low viscosity ink, whereby the segments lie along the troughs of the relief structure.

64. The method of claim 62, wherein the low viscosity ink contains conducting nanoparticles (suitable coated) in a liquid or resin vehicle.

65. The method of claim 63, wherein the conducting nanoparticles are present at a concentration which is proportional to the width of the segments.

66. The method of claim 64, wherein the conducting nanoparticles have at least one dimension which is proportional to or smaller than the width of the segments.

67. The method of claim 63, further comprising the step of removing the vehicle to form the segments.

68. The method of claim 59, comprising the step of applying a third layer of a dielectric material, wherein the dielectric material of the third layer has a refractive index nt which is different to np.
